(19) United States
(12) Patent Application Publication
(10) Pub. No.: US 2026/0152109 A1
(43) Pub. Date: Jun. 4, 2026

(54) TILT-DECK TRAILER AND SKID SYSTEM

(71) Applicant: The Will-Burt Company, Orrville, OH (US)

(72) Inventors: Michael Ermon Deaton, Noel, MO (US); Douglas Brent Enns, Stillwater, OK (US); Barry Ottis Page, Woodstock, GA (US)

(73) Assignee: The Will-Burt Company, Orrville, OH (US)

(21) Appl. No.: 19/407,291

(22) Filed: Dec. 3, 2025

Related U.S. Application Data
(60) Provisional application No. 63/727,788, filed on Dec. 4, 2024.

(51) Int. Cl. B60P 1/04; B60P 1/32; B60P 1/64; B60P 7/135

(52) U.S. Cl. CPC B60P 1/045; B60P 1/6409; B60P 1/6427; B60P 7/135; B60P 1/32

(57) ABSTRACT

A modular tilt-deck trailer and skid system is disclosed for transporting and deploying skid mounted payloads in diverse field environments. The system comprises a trailer portion configured for towing behind a vehicle, a pivotable tilt deck actuated by a tilt jack, and a winch assembly enabling controlled loading and unloading of standardized skids. Each skid integrates leveling jacks for terrain compensation and a mast tilt system for vertical deployment of various payloads such as surveillance, communication, or environmental devices. Securement of the skid to the tilt deck is achieved through a cam lock mechanism, as well as skid restraint forks and skid restraint pockets, allowing for rapid decoupling and recoupling of the skid to the tilt deck. The system supports interchangeable skid configurations and mast geometries, including telescopic and non-telescopic variations. Methods for deployment and reloading are also disclosed.

### BACKGROUND

The present disclosure relates generally to trailer-borne equipment handling and, more specifically, to a tilt-deck trailer and skid system configured to transport and deploy skid-mounted payloads. While particularly suited for applications involving vertical mast deployment, such as in surveillance, communication, or environmental monitoring applications, the disclosed system is adaptable to a wide range of operational scenarios.

In many field deployments, trailer implementations that couple payload structures directly to the trailer can limit how the trailer is used during deployment activities and can complicate repeatable loading, unloading, or reconfiguration. It is desirable to accommodate varied payload and mast geometries without requiring structural modification of the trailer while maintaining predictable handling and transport.

It is further desirable to provide trailer and skid arrangements that facilitate predictable engagement and retention during transport, enable efficient loading and unloading, and permit on-trailer stabilization or operation when appropriate. The present disclosure addresses these considerations with a tilt-deck trailer and a cooperating removable skid that can be coupled, secured, deployed, and decoupled in a repeatable manner across a range of payload geometries and specifications.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

The disclosed system provides a modular, transportable, and field deployable platform designed to support skid-mounted payloads for a wide range of operational environments. The present disclosure comprises at least a trailer/tilt assembly, a winch-driven loading mechanism, and a vibration-resistant cam lock retention system, engineered to facilitate secure transport, rapid deployment, and repeatable engagement of specialized equipment. The system is particularly suited for payloads requiring vertical mast deployment, such as surveillance, communications, meteorological, or environmental monitoring systems.

The trailer includes a pivotable tilt deck actuated by a tilt jack, enabling angular displacement for loading and unloading operations. The tilt deck is configured to receive a standardized skid, which may be pre-loaded with operation-specific equipment. A winch assembly mounted to the trailer interfaces with the skid via a winch cable, allowing the skid to be lowered off the tilt deck as well as allowing reloading of the skid. The skid is secured to the tilt deck via skid restraint forks and corresponding skid restraint pockets, as well as with cam lock mechanisms. The cam lock mechanism attached to the trailer engages corresponding features on the skid, securing the skid to the tilt deck.

The skid is equipped with adjustable leveling jacks for ground deployment on uneven terrain. A mast tilt assembly is integrated into the skid, enabling vertical deployment of a mast/payload.

The modular nature of the system allows for interchangeability between different skid configurations, supporting various operational requirements without the need for structural modification to the trailer.

The payload may comprise a methane gas leak detection system, a surveillance system, a camera, a radar system, a counter UAS (CUAS), an antenna, an RF device, a general communications device, a cellular communications device, and/or a satellite communications device.

The telescopic mast may comprise a circular, tubular telescopic mast, which uses a hand cranking mechanism to move the mast between its nested and extended positions. Alternatively, the telescopic mast may comprise a square or rectangular tube mast, a pneumatic mast, an electromechanical mast, or a non-telescoping mast.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a front-left perspective view of a tilt-deck trailer and skid system in a transport (horizontal) position in accordance with exemplary embodiments;

FIG. 2 is a plan view of the tilt-deck trailer and skid system in the transport (horizontal) position in accordance with exemplary embodiments;

FIG. 3 is a right-side elevation view of the tilt-deck trailer and skid system in the transport (horizontal) position in accordance with exemplary embodiments;

FIG. 4 is a front elevation view of the tilt-deck trailer and skid system in the transport (horizontal) position in accordance with exemplary embodiments;

FIG. 5 is a left-side elevation view of the tilt-deck trailer and skid system with the skid decoupled and supported by leveling jacks in accordance with exemplary embodiments;

FIG. 6 is a right-side elevation view of the tilt-deck trailer and skid system with a callout to Detail B in accordance with exemplary embodiments;

FIG. 7 is a detail view (Detail B) of a skid restraint fork and a skid restraint pocket in accordance with exemplary embodiments;

FIG. 8 is a detail view of a skid restraint fork engaged within a skid restraint pocket in accordance with exemplary embodiments;

FIG. 9 is a perspective view of a cam-lock subassembly in a locked position in accordance with exemplary embodiments;

FIG. 10 is a perspective view of the cam-lock subassembly in a locked position in accordance with exemplary embodiments;

FIG. 11 is a flow diagram of a method for deploying a skid-mounted mast while the skid remains seated on the tilt deck in accordance with exemplary embodiments; and

FIGS. 12A-12E are a sequence of views illustrating representative steps of the method of FIG. 11.

### DETAILED DESCRIPTION

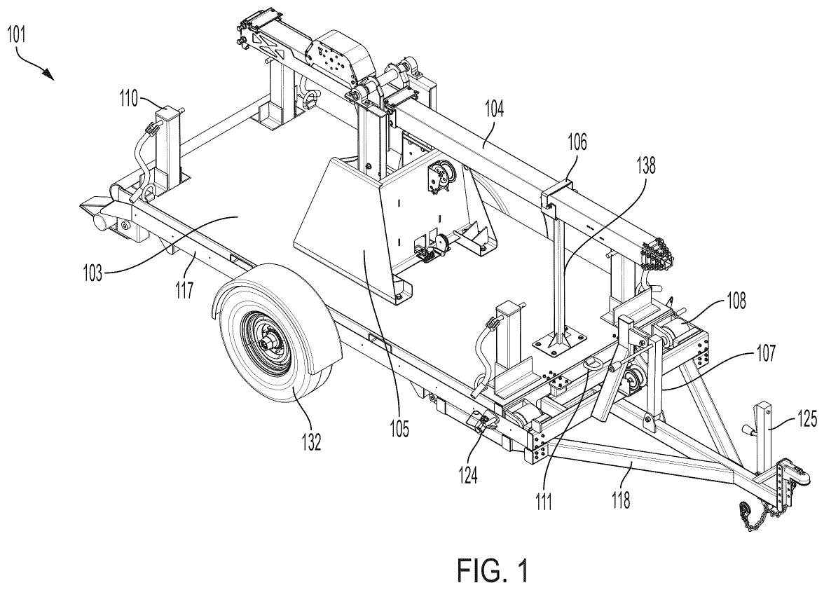

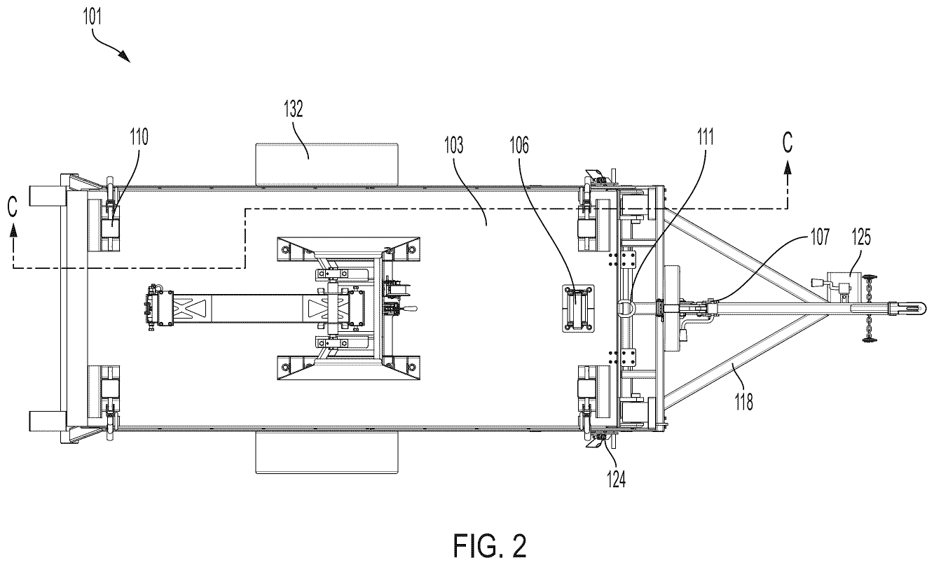

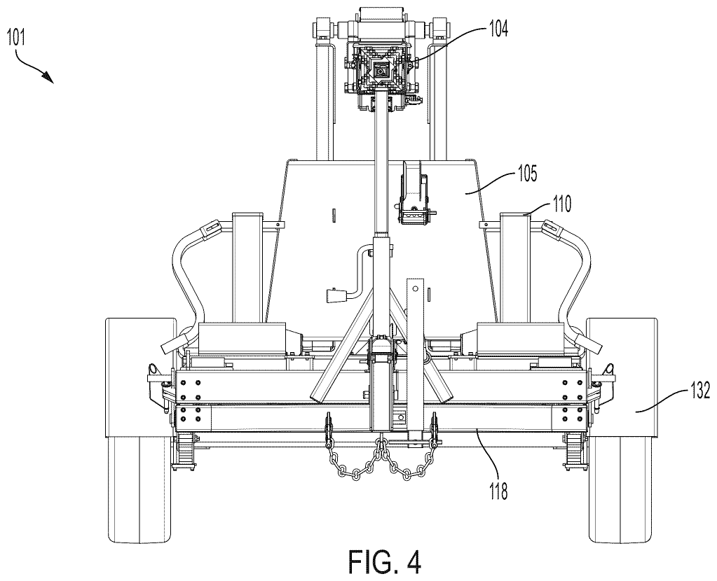

Referring now to FIGS. 1-5, an exemplary tilt-deck trailer and skid system 101 is illustrated, configured to facilitate secure loading, transport, and deployment of a skid mounted mast/payload apparatus. The system 101 comprises at least a single axle trailer integrated with a tilt mechanism, wherein the axle serves as a rotational fulcrum enabling angular displacement of the tilt deck 117 of the system relative to the ground plane.

The trailer assembly includes a ground support jack 125 positioned at a forward end of a trailer portion 118, which stabilizes and supports the system when it is detached from a vehicle hitch (not shown). A tilt jack 107 is operably disposed between the trailer portion 118 and a tilt deck 117, with each end joint of the tilt jack 107 pivotable. As used herein, trailer portion 118 refers to the forward, non-tilting structure configured to couple to a towing vehicle, and tilt deck 117 refers to the pivotable load-bearing platform that supports the skid 103. Extension or retraction of the tilt jack 107 induces angular motion of the tilt deck 117 about the wheel/axle assembly 132, adjusting the loading and unloading angle of the tilt deck 117.

A winch assembly 108 is mounted to the trailer portion 118 of the system and comprises a winch drum, a crank handle, and a winch cable. The cable terminates in a hook or loop fitting designed to engage a corresponding winch cable anchor 111 on the skid. The winch cable anchor 111 is preferably a reinforced lug or a cable eyelet, or equivalents.

The skid 103 includes four independently adjustable skid leveling jacks 110, each mounted proximate to one of the corners of the skid 103. The skid leveling jacks 110 enable precise leveling and alignment even when the skid 103 is utilized on uneven or rough terrain.

The skid 103 further incorporates a mast tilt system 105, comprising a pivot mounted mast 104 and a mechanical crank. The mast tilt system includes a base with side walls that supports a tilt frame. A mast is mounted to the tilt frame, which pivots about a tilt rotation axis. Rotation of the crank transitions the mast 104 from a stowed horizontal position to an upright vertical position. It is appreciated that the angle of the upright position is typically 90 degrees, however, slight variations may be appropriate depending on the circumstances of deployment of the system. The mechanical crank can be hand operated, or it may alternatively be powered.

The skid is coupled to the system via a cam-lock subassembly 124. The cam-lock subassembly 124 includes a rotatable cam-lock arm 119 mounted to the tilt deck 117 and a cam-lock skid pin 120 extending from the skid 103. Upon engagement, the cam-lock subassembly 124 provides secure stabilization and vibration resistance during transport while allowing rapid decoupling when deployment of the skid 103 is required.

As used herein, the “arm angle” is the acute angle between (i) the longitudinal axis of the cam-lock arm 119 and (ii) a plane defined by the upper surface of the tilt deck 117, measured when the cam-lock arm 119 is in its locked position engaging the cam-lock skid pin 120. The arm angle is measured relative to a plane P defined by the upper surface of the tilt deck 117 (see FIG. 10). In preferred embodiments, the arm angle is less than 90 degrees, preferably between 30 and 70 degrees or even between 40 and 60 degrees.

Generally, when the arm angle is acute relative to the deck plane, the geometry of the cam-lock arm 119 produces a retention force vector with a substantial downward component on the cam-lock skid pin 120. During transport, road-induced vibration and shock can impose upward accelerations on the skid 103 relative to the tilt deck 117. With an acute arm angle, the normal reaction between the arm's engagement surface and the skid pin 120 resolves into both a longitudinal component and a downward component, thereby resisting upward displacement of the skid 103. In contrast, when the arm angle approaches or exceeds 90 degrees, the vertical component of the reaction force diminishes, reducing resistance to lift-off during dynamic events.

In certain embodiments, the cam-lock arm 119 may incorporate an eccentric cam profile or offset pivot that increases normal force as the arm rotates into the locked position, further enhancing the downward force component on the skid pin 120. A removable safety pin 121 may be inserted through aligned apertures in the cam-lock arm 119 and a mounting bracket of the cam-lock subassembly 124 when the prescribed arm angle is achieved, providing a visual and mechanical confirmation that the lock is engaged within the target range.

The components of the tilt-deck trailer and skid system 101 may be formed from aluminum, steel, stainless steel, or fiber-reinforced composites, with corrosion-resistant finishes such as galvanization, powder coating, anodizing, or paint, or equivalents.

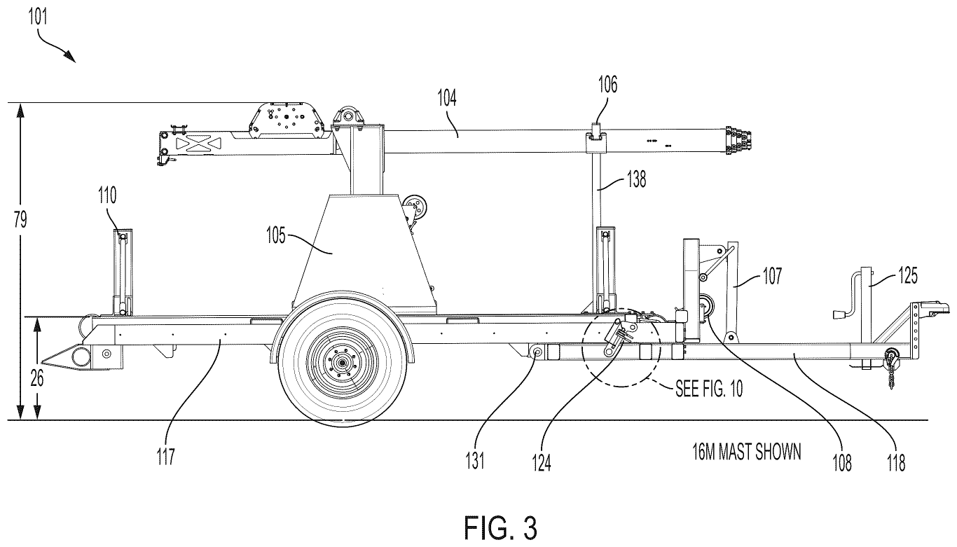

Referring to FIG. 3 specifically, the system is configured as two portions: a forward trailer portion 118 and a rearward tilt deck 117. The trailer portion 118 is configured to couple to a towing vehicle hitch and serves as a base for non-tilting components. The tilt deck 117, which includes the wheel/axle assembly 132 and the load-bearing platform, is configured to support and transport the skid 103.

The tilt deck 117 is coupled to the trailer portion 118 via a rotatable joint 131 such as a hinge or pivot pin assembly, enabling angular displacement of the tilt deck 117 relative to the trailer portion 118.

The wheel/axle assembly 132 defines the axis about which the tilt deck 117 is elevated or lowered. The angular displacement is actuated by the tilt jack 107 mounted between the two portions.

In the transport position, a portion of the tilt deck 117 may overlap the axle or a frame member such that the deck's center section is located at least partially above the wheel/axle assembly 132 or adjacent structural cross-members of the trailer portion 118. This overlap geometry can lower the combined center of gravity of the trailer-skid assembly and increase torsional and bending stiffness by shortening the effective unsupported deck span, thereby improving stability during transport. The deck pivot location and tilt jack 107 geometry are selected so that, in the lowered loading position, the rear edge of the tilt deck 117 approaches the ground for ramped access, while in the transport position, the overlapped region aligns with the wheel/axle assembly 132 and/or the trailer portion 118 to create a stable, interlocked structure.

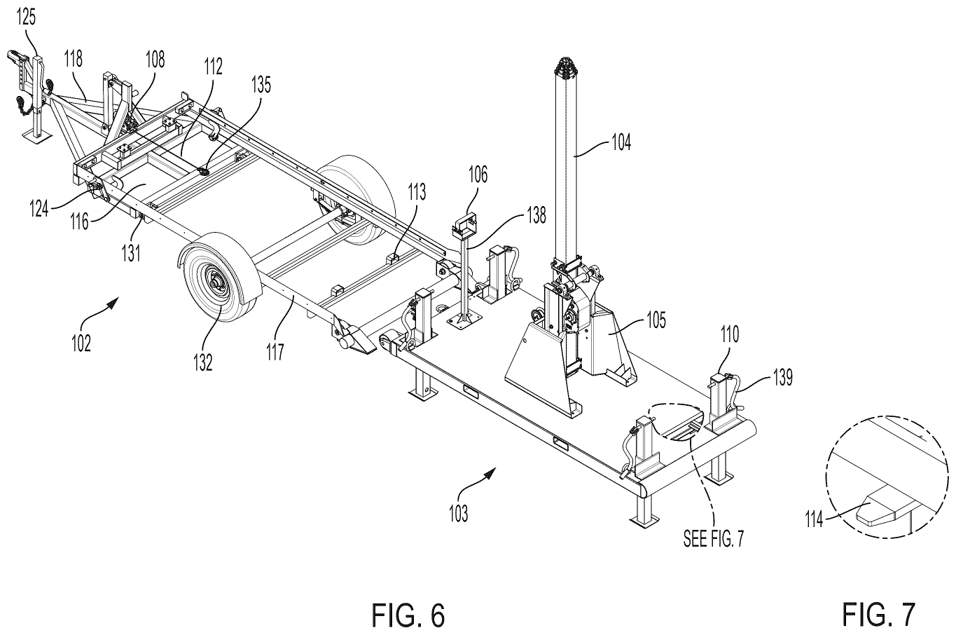

FIG. 6 shows a side view of the skid 103 attached to the tilt-deck trailer and skid system 101. The skid 103 is locked in place by a cam-lock subassembly 124 mounted at a forward region of the tilt deck 117. The skid 103 may include one or more rollers 140 positioned adjacent the skid edges, and the tilt deck 117 may include edge tracks along opposing sides to guide the skid 103 during loading and unloading. The edge tracks can be provided as welded rails or channels with cross-sections selected to mate with the rollers 140. Representative track cross-sections include rectangular channels, V-grooves, or keyed profiles; corresponding roller profiles may be cylindrical, V-grooved, or flanged to maintain tracking. The guided roller/track interface reduces friction and misalignment during winch-assisted loading, helps prevent racking of the skid 103 relative to the tilt deck 117, and protects the deck surface from localized wear. In some embodiments, the track surfaces are hardened or fitted with replaceable wear strips, and the rollers 140 include sealed bearings to reduce maintenance.

A ground jack 125 is affixed to the forward end of the trailer portion 118 of the system, proximate to a forward mounting region of the trailer portion 118. The ground jack 125 serves as a ground stabilizing support when the tilt-deck trailer and skid system 101 is decoupled from the towing vehicle. The ground jack 125 may be manually actuated via a hand crank mechanism or alternatively, the jack may be powered through motorized, pneumatic, hydraulic, or electric means. In automated embodiments, the ground jack 125 may include limit switches and load sensors to regulate extension height.

A tilt jack 107 is mounted at one distal end of the trailer portion 118 and at the opposite distal end to the tilt deck 117. The tilt jack 107 may be attached to both portions of the system using reinforced brackets, to ensure load bearing capabilities. The tilt jack 107 may be manually operated with a hand crank or alternatively, the tilt jack 107 is powered through motorized, pneumatic, hydraulic, or electronic means, depending on the payload and system requirements. As used herein, “payload” includes, without limitation, masts and mast-mounted devices such as cameras, imaging systems, surveillance systems, RF devices, antennas, communications equipment, and sensing modules (e.g., methane leak detection), and combinations thereof.

Upon extension, the tilt jack 107 elevates the forward edge of the tilt deck 117, causing the rear edge of the tilt deck 117 to descend until it contacts the ground surface. This creates an inclined plane suitable for loading and unloading the skid 103. In some embodiments, the tilt jack 107 may include sensors to monitor the tilt angle. The tilt jack 107 may further include stops at metered positions, enabling the operator to set and lock the tilt deck 117 of the system at a specific predetermined angle. In another embodiment, the tilt jack 107 may include overload protection features such as pressure relief valves or torque limiters, to prevent mechanical failure. The rotatable joint 131 between the trailer and tilt decks may include bushings or bearings to reduce friction and wear from repeated use.

A winch assembly 108 is mounted to the trailer portion 118 of the system. The winch assembly 108 comprises a winch crank that may be manually operated via a hand crank or alternatively, the winch assembly 108 may be powered by motorized, pneumatic, hydraulic, or electric means. The winch assembly 108 comprises a tensile winch cable 112 and a winch cable hook 135. The winch cable 112 may be made of steel wire rope, high-strength synthetic fiber, or any other suitable material for bearing heavy loads.

The winch cable 112 terminates in a winch hook 135 or clevis fitting designed to engage a corresponding winch cable anchor 111 on the skid. The winch cable anchor 111 is preferably a reinforced lug, or cable, or equivalents. The winch assembly 108 may include a friction brake, ratcheting mechanism, or dynamic tension control to prevent uncontrolled descent and ensure operational safety.

In one embodiment, the winch assembly 108 includes a freewheel or neutral setting, enabling the winch cable 112 to unspool from the winch drum without resistance. This mode allows for rapid deployment but requires monitoring by the operator to ensure proper deployment. Alternatively, the winch assembly 108 may be configured for a metered payout, wherein each crank rotation of a winch crank corresponds to a release of a fixed cable length, allowing precise control over skid movement.

In some embodiments, the winch assembly 108 may include load sensors, cable tension indicators, or automatic shutoff features to prevent overloading or cable failure. Once the skid 103 is fully seated on the tilt-deck trailer and skid system 101, and the tilt-deck trailer and skid system is returned to its horizontal orientation, the winch cable 112 may be disconnected from the skid 103 and respooled on the winch drum for storage.

The skid 103 comprises four skid leveling jacks 110, each mounted at a respective corner of the skid 103. The skid leveling jacks 110 enable vertical adjustment for terrain compensation and operational leveling. The skid leveling jacks 110 may be manually operated with a hand crank 137 or alternatively, the skid leveling jacks 110 may be powered by motorized, pneumatic, hydraulic, or electric means. Each skid leveling jack 110 includes a telescoping arm, base plate, and locking mechanism to maintain position under load. When fully retracted, the skid leveling jacks 110 are designed to remain flush with the underside of the skid 103, preventing interference while loading and unloading of the skid 103.

The tilt deck 117 includes a plurality of jack pockets 116 formed through the deck surface and positioned to align with leveling jacks 110 on the skid 103 when the skid 103 is seated. The jack pockets 116 allow the leveling jacks 110 to be deployed while the skid 103 remains on the trailer, facilitating on-trailer leveling, setup, or operation of equipment mounted to the skid 103. This allows for rapid deployment of a skid 103 as well as rapid takedown and removal of the same system.

The jack pockets 116 may include welded collars, bushings, or reinforcing sleeves to distribute load into the tilt deck 117 structure and to resist deformation under jack loads. Clearances around the jack feet are sufficient to allow vertical actuation without interference, while maintaining lateral guidance. In certain embodiments, the jack pockets 116 remain accessible in both loading and transport positions of the tilt deck 117, and removable covers may be provided to protect the openings when not in use.

The present tilt-deck trailer and skid system is configured to support a wide range of mast assemblies and payloads. Exemplary mast systems can include locking and non-locking telescopic masts of various heights and payload capacities (e.g., circular or rectangular tube masts). Other acceptable masts may vary in height, shape (including circular, square, triangular, oval, etc.), and payload capacity. Further, it is contemplated that telescoping, non-telescoping, and other types of masts are compatible with the present tilt-deck trailer and skid system. The present tilt-deck trailer and skid system 101 is typically used in conjunction with mast systems for surveillance, communications, lighting, or environmental monitoring. The masts used in the present disclosure are also compatible for guying, if the application requires it.

The mast 104 is mounted to the skid 103 via a mast tilt system 105, which enables transition between a horizontal stowed position and a vertical deployed position. The mast tilt system 105 may comprise a pivot bracket, a crank actuator, locking detents, and/or a damping mechanism to control motion and prevent shock loading. The crank actuator may be manually operated with a hand crank or alternatively, the crank actuator may be powered by motorized, pneumatic, hydraulic, or electronic means. Alternatively, the mast can be mounted vertically to a fixed base that does not tilt.

In some embodiments, the mast tilt system 105 may include safety interlocks to prevent the mast deployment unless the skid 103 is fully leveled and stabilized. Additionally, the mast 104 and mast tilt system 105 may be equipped with cable management features to support electrical or data collection connections to the payload. Payloads mounted to the mast 104 may include, but are not limited to, methane gas leak detection sensors, surveillance systems, cameras, radars, counter UAS (CUAS), antennas, RF devices, general communications, cellular communications, and satellite communications. The various payload devices may be powered by on board batteries, solar panels, or external power supplies.

The skid further includes a mast latch assembly 106 that secures the mast in the horizontal position. The mast latch assembly 106 includes a latch attached atop a mast bracket post 138 that is coupled to the skid 103. The mast latch assembly 106 is at such a height so that when the mast 104 is tilted into its horizontal orientation, the mast 104 is secured within the mast latch assembly 106 in a configuration parallel to the ground. The mast latch assembly 106 is located at the forward part of the skid 103. The mast bracket latch assembly 106 comprises a bottom portion that is complementarily configured to receive the geometric shape of the mast 104, and a top latch connected to the bottom portion of the mast latch assembly 106 by a hinge. The latch can be rotated about the hinge so that it encloses the mast 104 between the bottom portion of the mast latch assembly 106 and the top latch portion, securing the mast 104 in place. The mast latch assembly 106 may further include padding or other material to protect against vibration or mechanical wear during transportation.

Referring again to FIG. 6, once the skid 103 has been offloaded from the tilt-deck trailer and skid system 101 and placed on the ground, it may be leveled using four integrated skid leveling jacks 110. The skid leveling jacks 110 are positioned at each corner of the skid 103 and allow for vertical adjustment to compensate for uneven terrain.

FIG. 6 further illustrates the disengaged state of the skid 103 and tilt-deck trailer and skid system 101, with the skid leveling jacks 110 extended. The tilt deck 117 of the trailer includes integrated skid restraint pockets 113, which are geometrically matched to receive the skid restraint forks 114 mounted on the skid 103. During loading, the skid restraint forks 114 interlock with the skid restraint pockets 113, forming a secure interface and preventing the rear end of the skid 103 from decoupling from the tilt-deck trailer and skid system 101. As used herein, skid restraint forks 114 and skid restraint pockets 113 refer to complementary mating structures located at rear portions of the skid 103 and tilt deck 117, respectively.

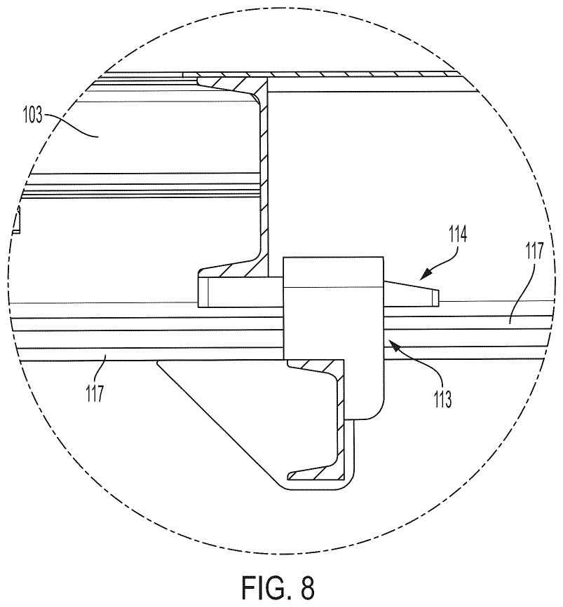

FIGS. 7-8 show the skid restraint pockets 113 designed to be complementary in shape and dimension to the skid restraint forks 114, ensuring a snug fit that resists lateral and vertical displacement during transit. This interlocking mechanism allows for secure transport while also facilitating quick and repeatable engagement and disengagement across multiple skid units. Optional locking inserts or vibration-damping inserts may be incorporated to further secure the connection and protect against mechanical wear.

The skid 103 includes a pair of forks 114 located at a rear portion of a base frame, and the tilt deck 117 includes a corresponding pair of complementary skid restraint pockets 113 located at a rear portion of the deck. Each pocket 113 is configured to receive a corresponding fork 114 with close lateral clearance to limit side-to-side play and with a vertical bearing surface to resist lift. In some embodiments, the forks 114 have tapered leading portions to facilitate alignment and insertion, and the pockets 113 include complementary tapered entries or guide chamfers. The pockets 113 may incorporate liners or damping elements, such as replaceable polymer wear pads (e.g., UHMW-PE or nylon), elastomeric pads, or composite inserts, to reduce vibration, wear, and noise during transport. Optional detents, stops, or undercuts within the pockets 113 can engage mating features on the forks 114 (e.g., grooves or shoulders) to resist longitudinal motion. Secondary locking mechanisms, such as transverse locking pins, latch bars, or captive wedges, may secure the forks 114 within the pockets 113 after seating. In representative constructions, the pockets 113 are fabricated from steel plate and structural sections welded to the deck structure of the tilt deck 117.

Each skid restraint fork 114 is typically fabricated from high strength and resistance materials and may be reinforced with gussets or cross bracing to resist torsional force under dynamic conditions during transport of the system. In a preferred embodiment, the skid restraint forks 114 are rectangular and flat, which provides a broad contact surface area and enhances the load distribution. However, alternative geometries are contemplated to accommodate varying trailer and operational requirements. Some embodiments may include tapered forks for guided alignment, radiused or chamfered edges to reduce friction and help guide engagement, or keyed profiles for increased anti rotation engagement. The skid restraint pockets 113 may be lined with bushings or vibration damping inserts to mitigate wear and reduce noise during transit.

In some embodiments, the skid restraint forks 114 may be optionally repositioned or replaced to suit different trailer models or skid configurations.

The skid restraint pockets 113 may also optionally incorporate secondary locking features, such as spring-loaded detents, cam levers, and/or pins to prevent accidental disengagement of the skid from the tilt-deck trailer and skid system.

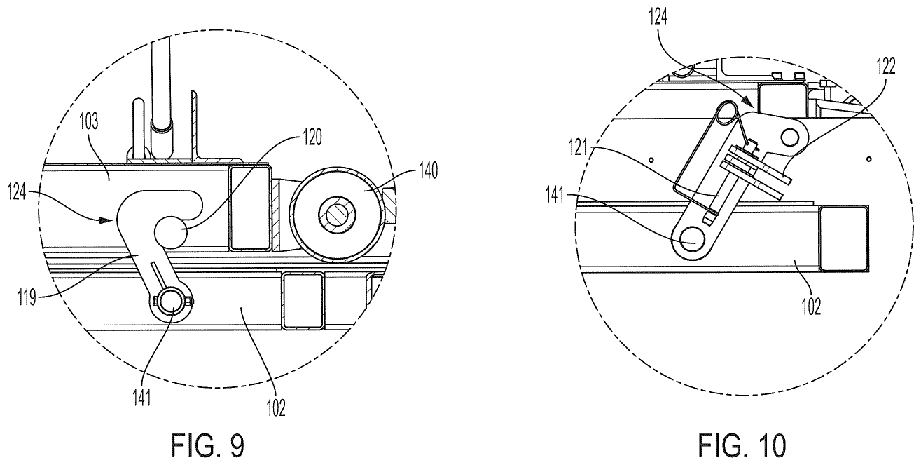

FIGS. 9-10 show a cam lock 124 comprising a cam lock arm 119 positioned at an angle of less than 90 degrees, typically between 30 degrees and 70 degrees relative to the tilt deck. The cam lock arm 119 engages a cam lock skid pin 120 on the skid 103, securing the skid 103 to the tilt-deck trailer and skid system 101. It should be appreciated that the angle of the cam lock arm 119 is advantageous for reducing slippage and vibration during transportation of the tilt-deck trailer and skid system. The cam-lock arm 119 rotates about a cam-lock pivot pin 141 coupled to the tilt deck 117. As the cam lock arm 119 rotates, its eccentric profile drives the hooked tip of the cam lock arm 119 around the protruding cam lock skid pin 120 that is either welded on or cast into the skid 103, locking it in place with increasing force until it reaches the desired angle, securing the skid 103 to the tilt-deck trailer and skid system 101.

In particular embodiments, the cam lock 124 features a hook shaped cam lock arm 119 that engages a protruding cam-lock skid pin 120 extending from the skid 103. The cam lock has a removable safety pin 121 that, upon insertion into the cam lock arm 119, restricts the cam lock arm 119 from rotating and unsecuring the skid 103. The cam lock arm 119 rotates about a cam lock pivot pin 141 which is coupled to the tilt-deck trailer and skid system 101. Further, removal of the safety pin 121 allows disengagement of the cam lock 124 for removal of the skid 103 from the tilt-deck trailer and skid system 101. The cam lock 124 may preferably be located on the outside of the tilt-deck trailer and skid system 101. However, other embodiments may require the cam lock 124 in various locations on the tilt-deck trailer and skid system 101, with a corresponding attachment piece (i.e., a cam lock skid pin) located in a corresponding location on the skid 103.

During transport, the angled cam lock arm 119 geometry offers multiple benefits. By maintaining a component of vertical force on the cam lock skid pin 120, it suppresses any tendency of the skid 103 to lift off the tilt-deck trailer and skid system 101 due to sudden bumps during transport. The angle of the cam lock arm 119 also provides added support against sudden accelerations during transport.

Removal of the skid 103 requires the safety pin 121 be removed and the cam lock arm 119 be moved to the open, or horizontal position. The operator may then start the unloading process of the skid 103. For re-securing the skid 103 to the tilt-deck trailer and skid system 101, the operator will return the skid 103 to the tilt-deck trailer and skid system 101, return the system to its horizontal or flat position, ensure the skid 103 fully engaged on the trailer (i.e., the skid 103 is in the fully forward position on the tilt-deck trailer and skid system 101), and rotate the cam lock arm 119 so that it wraps around the protruding cam lock skid pin 120 until it reaches its locking position. The operator then inserts the safety pin 121 into the cam lock arm 119, preventing disengagement of the cam lock arm 119 from the cam lock skid pin 120, and securing the skid 103 to the tilt-deck trailer and skid system 101.

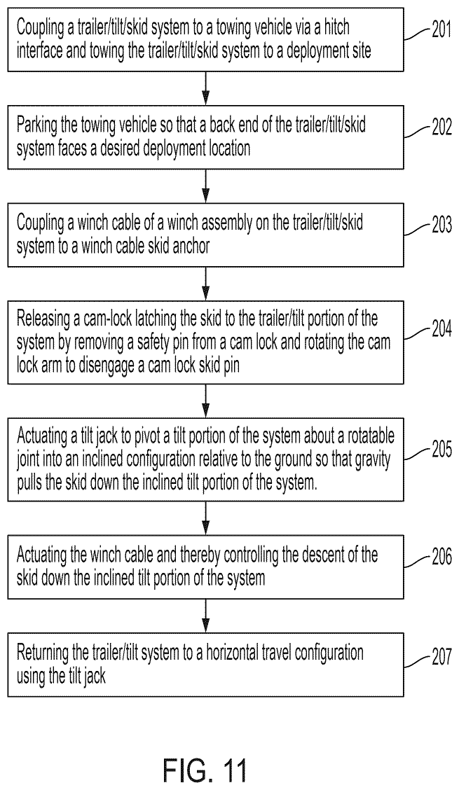

Referring to FIG. 11, a representative method of deploying a skid-mounted mast system includes: (201) coupling a tilt-deck trailer and skid system 101 to a towing vehicle via a hitch interface and transporting the system to a deployment site; (202) parking the vehicle so that a back end of the system 101 faces a desired skid deployment location; (203) coupling a winch cable 112 of a winch assembly 108 on the system 101 to a winch cable anchor 111 on the skid 103; (204) releasing a cam-lock subassembly 124 that latches the skid 103 to the system 101 by removing a safety pin 121 and rotating a cam-lock arm 119 to disengage a cam-lock skid pin 120; (205) actuating a tilt jack 107 to pivot a tilt deck 117 about a rotatable joint 131 into an inclined configuration relative to the ground so that gravity pulls the skid 103 down the inclined tilt deck 117; (206) actuating the winch assembly 108 to pay out the winch cable 112 and thereby control the descent of the skid 103 down the inclined tilt deck 117; and (207) returning the system 101 to a horizontal travel configuration using the tilt jack 107.

In some scenarios, the skid/payload may be lightweight, and the effect of gravity may not be enough to pull the skid entirely off the trailer/tilt system. In such a scenario, the operator may slowly drive the vehicle attached to the trailer/tilt system forward so that the trailer/tilt system is removed from beneath the skid, and the skid is fully disengaged from the trailer/tilt system.

The operator may then level the skid by activating one or all of the plurality of skid leveling jacks. Once the skid is level and secure, the operator may unlatch the mast bracket clamp and tilt the mast into its upright position by activating the mast tilt crank. Once the mast is in its fully upright position, the operator may raise the payload by extending the mast using a mast crank.

Optionally, the operator may tilt and extend the mast without removing the skid from the tilt-deck trailer and skid system. In such a scenario, the tilt-deck trailer and skid system remains fully engaged, and the mast clamp is unlatched to allow the mast to be tilted using the mast tilt crank. The mast may then be extended using the mast crank.

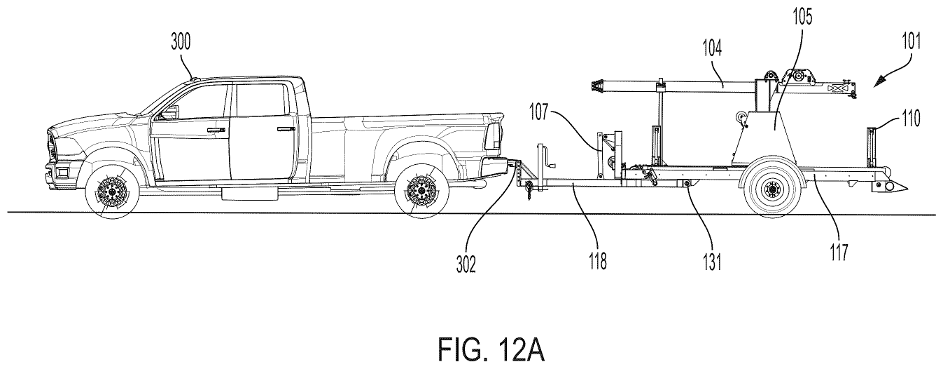

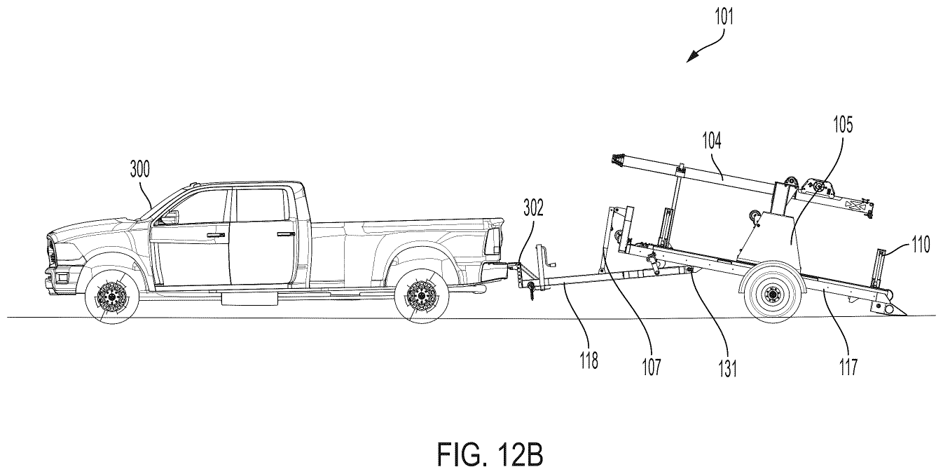

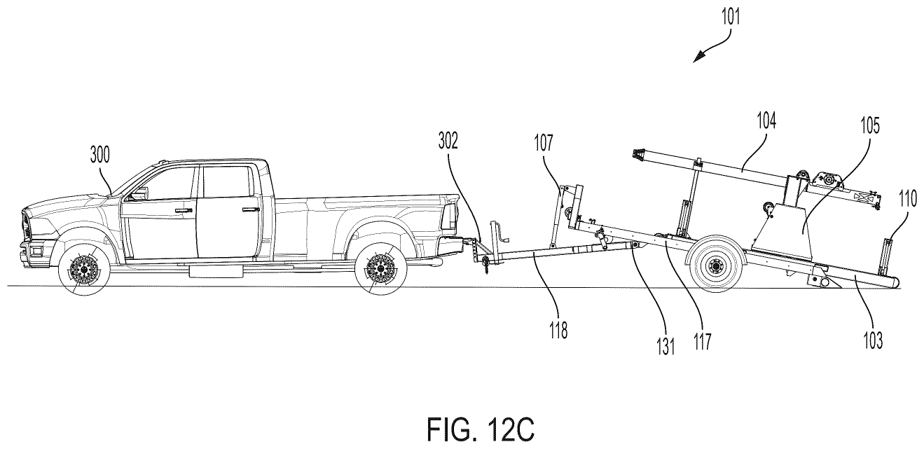

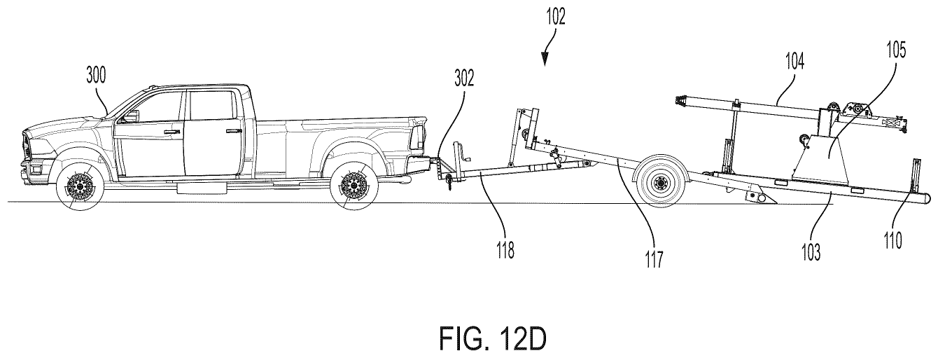

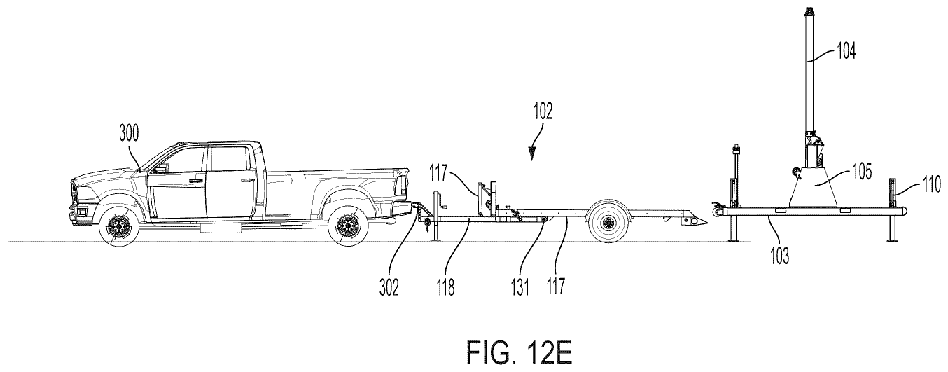

Referring to FIG. 12A, the tilt-deck trailer and skid system is shown in its fully assembled and transport-ready configuration. In this state, the trailer portion 118 is securely coupled to the towing vehicle 300 via a standard hitch receiver 302. The tilt deck 117 of the tilt-deck trailer and skid system 101 is locked in its horizontal position via the tilt jack 107. The skid 103 (as shown in FIG. 1, feature 103) is mounted atop the tilt-deck trailer and skid system 101 and held in place by the skid cam locks (as shown in FIG. 6, feature 124) on the front end of the tilt deck 117 and by skid restraint forks and pockets (as shown in FIG. 8, features 114 and 113) on the rear of the tilt deck 117. In this configuration, the winch cable (as shown in FIG. 7, feature 112) is fully spooled onto the winch assembly (as shown in FIG. 1, feature 108), and the winch assembly 108 is secured in its locked position to prevent unintended payout of the winch cable 112. The leveling jacks 110 on each corner of the skid are fully retracted to avoid ground or trailer contact. The entire system is configured to meet applicable Department of Transportation regulations for trailer height, width, and load securement.

Referring to FIGS. 12B-12C, upon arrival at the deployment site, the towing vehicle 300 is brought to a complete stop on level ground (need not be perfectly level). The engine is turned off and the parking brake is engaged to prevent unintended vehicle movement. Wheel chocks may be placed under the trailer tires as an additional safety measure, particularly if the terrain is sloped. The operator then initiates the unloading sequence by disengaging the skid cam lock 124 mechanism by rotating the cam lock arm (as shown in FIGS. 9-10, feature 119) to release the cam lock arm 119 from around the cam-lock skid pin 120.

Prior to tilt actuation, the winch cable 112 must be securely connected to the winch cable anchor (as shown in FIG. 1, feature 111) on the skid frame. The winch cable 112 serves as both a motive and restraining element during the unloading process. The winch assembly 108 is then released, allowing the winch cable 112 to payout. Depending on the winch design, this may be achieved via a ratcheting mechanism, friction brake, or gear-reduction system that permits controlled payout in metered intervals. Controlled payout is preferred in scenarios requiring a more precise placement of the skid 103.

Once the winch cable 112 is properly attached and tensioned, and the skid 103 is free to move, the tilt jack 107 is actuated to elevate the tilt deck 117 of the tilt-deck trailer and skid system 101. As the tilt jack 107 extends, the tilt deck 117 of the system rotates about its hinge axis, increasing the angle of inclination relative to the trailer portion 118 of the system and the ground. This angular displacement creates a gravitational vector that acts upon the skid 103. As the tilt angle increases, the skid 103 begins to slide on its low friction rollers along the inclined tilt deck 117. The skid restraint forks (as shown in FIG. 8, feature 114) of the skid 103 disengage from within the skid restraint pockets (as shown in FIG. 8, feature 113) of the tilt deck 117 as the skid 103 slides down the tilt deck 117. The winch cable 112 serves as a restraint, limiting the rate and extent of movement of the skid 103. The operator may modulate the winch assembly 108 to adjust winch cable 112 tension and descent in real time. Once the skid 103 reaches the ground and achieves stable contact, the towing vehicle 300 may be advanced forward at a low speed, thereby withdrawing the tilt-deck trailer and skid system 101 from beneath the skid 103. This completes the unloading sequence, and at this point, the skid 103 remains stationary on the ground.

Following successful unloading, the winch cable 112 is disconnected from the skid 103 and respooled onto the winch assembly 108 for storage. The operator may then deploy the skid leveling jacks 110 to achieve ground stabilization.

Referring to FIG. 12D, in certain deployment scenarios, the towing vehicle 300 may be advanced slowly to allow the skid 103 to complete its descent from the tilt-deck trailer and skid system 101 under controlled conditions. This maneuver may be used when the tilt-deck trailer and skid 101 system is particularly light weight, and gravity alone fails to decouple the skid 103 from the tilt deck 117. The winch cable 112 may optionally remain attached for this step to prevent abrupt motion that may be undesired. Once the skid 103 is fully engaged with the ground, the winch cable 112 is disconnected from the skid 103 and is respooled onto the winch assembly 108.

Referring to FIG. 12E, once the skid 103 has been fully removed from the tilt-deck trailer and skid system 101, the tilt jack 107 is retracted to return the tilt deck 117 to its transport-ready, horizontal, configuration. The skid 103 is leveled using the leveling jacks 110, and the mast 104 may be transitioned into its vertical, upright position using the tilt mechanism 105. The tilt-deck trailer and skid system 101 may then be repositioned or used to retrieve and transport an alternative skid unit. The modular nature of the system allows for rapid redeployment and supports a wide range of skid mounted payloads including generators, communication masts, or other field-deployable equipment.

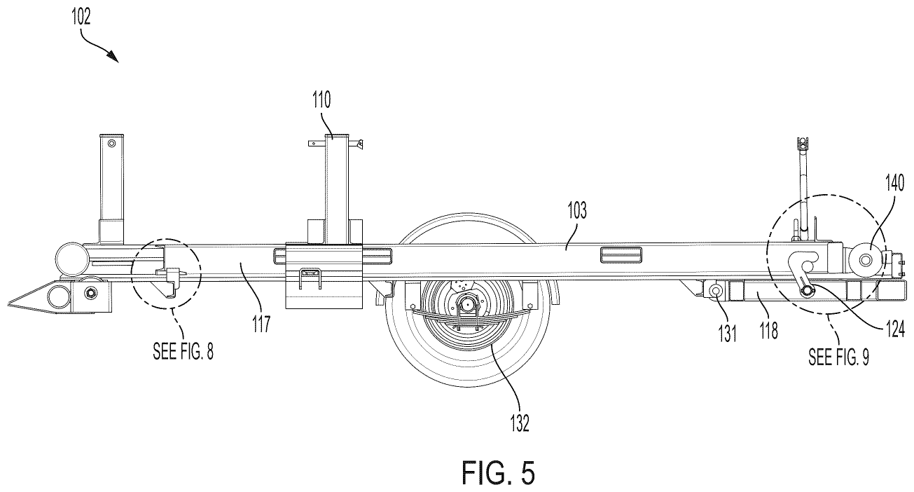

To initiate reloading of the skid 103 onto the tilt-deck trailer and skid system 101, the towing vehicle 300 with the tilt-deck trailer and skid system 101 is reversed into alignment with the stationary skid 103. Proper alignment is critical to ensure that the skid rollers (as shown in FIG. 5, feature 140) are aligned with their corresponding tracks on the tilt-deck trailer and skid system 101. Prior to engagement, the skid leveling jacks 110 must be fully retracted so that the skids rollers 140 are in direct contact with the ground and the mast 104 must be rotated into its horizontal, flat position using the tilt mechanism 105. The tilt jack 107 is then extended to lower the rear end of the tilt deck 117 into contact with the ground, forming a ramp interface. The winch cable 112 is affixed to the skid's winch cable anchor 111, and the winch assembly 108 is operated to draw the skid 103 forward along the inclined tilt deck 117. The winch cable 112 provides both motive force and positional control during ascent, allowing the operator to modulate speed and alignment in real time. In some embodiments, the winch assembly 108 may include a ratcheting mechanism, load brake, or gear reduction drive to enhance mechanical advantage and prevent rollback.

As the skid 103 ascends the tilt deck 117, the operator monitors the cable tension, roller alignment, and system stability. The skid restraint forks 114 of the skid 103 re-engage the skid restraint pockets 113 of the tilt deck 117 upon ascent of the skid 103 up the tilt deck 117. Once the skid 103 is fully engaged onto the tilt deck 117, the tilt jack 107 is retracted, returning the tilt deck 117 and the now mounted skid 103 to its horizontal configuration, parallel with the trailer portion 118 and the ground. The skid cam lock 124 is then engaged, securely fastening the skid 103 to the tilt-deck trailer and skid system 101. The skid cam lock 124 may include a secondary safety pin (as shown in FIG. 10, feature 121) to prevent accidental disengagement during transport.

Unless otherwise indicated, the components described herein may be formed from steel, aluminum, stainless steel, or fiber-reinforced composite materials, with corrosion-resistant coatings such as galvanization, powder coating, anodizing, or paint, or equivalents. The skid restraint pockets 113 may have rectangular, square, circular, or other polygonal cross-sections, and may include liners formed from UHMW-PE, PTFE-based composites, elastomers, or metallic wear plates, or equivalents. The forks 114 may be solid or hollow sections with rectangular, round, or tapered profiles, and may include keyed or shouldered features, or equivalents. The edge tracks may be channels, angles, V-rails, keyed rails, or modular wear strips, and the rollers 140 may be cylindrical, flanged, or V-grooved, with bushings or rolling-element bearings, or equivalents. The cam-lock subassembly 124 may employ a straight or contoured arm 119, an offset or concentric pivot, and a detent or over-center mechanism, with a removable or captive safety pin 121, tether, or secondary latch, or equivalents. The tilt jack 107 may be hydraulic, pneumatic, electric linear, or mechanical screw-type, or equivalents. Stated alternatives are exemplary and not limiting. Persons of ordinary skill will recognize that other structures providing the same functional cooperation are also contemplated.

What is claimed is:

1. A system for transporting and deploying a skid-mounted payload, comprising:
a trailer portion configured for attachment to a towing vehicle;
a tilt deck pivotally coupled to the trailer portion to define a rotatable hinge axis;
a tilt jack operable to move the tilt deck between a transport-ready, horizontal configuration and an inclined, ramp configuration;
a winch assembly mounted on the trailer portion; and
a skid removably coupled to the tilt deck, the skid comprising: a plurality of leveling jacks and a mast for supporting a payload.

2. The system of claim 1, wherein the skid is removably coupled to the tilt deck via skid restraint forks attached to the skid and corresponding skid restraint pockets on the tilt deck, and a cam-lock subassembly mounted to the tilt deck that engages a cam-lock skid pin protruding from the skid.

3. The system of claim 1, further comprising edge tracks disposed along opposing sides of the tilt deck, and wherein the skid includes rollers positioned to travel along the edge tracks during loading and unloading.

4. The system of claim 2, wherein, in a locked position, a cam-lock arm of the cam-lock subassembly engages the cam-lock skid pin at an acute arm angle relative to a plane of the tilt deck that is less than 90 degrees.

5. The system of claim 4, wherein the arm angle is between 30 and 70 degrees in the locked position.

6. The system of claim 5, wherein the arm angle is between 40 and 60 degrees in the locked position.

7. The system of claim 2, wherein the cam-lock arm includes an eccentric cam profile configured to increase normal force as the cam-lock arm rotates into the locked position.

8. The system of claim 2, wherein the cam-lock subassembly includes a removable safety pin tethered to the subassembly and having a positive-locking retainer.

9. The system of claim 2, wherein the skid restraint pockets include liners comprising ultra-high-molecular-weight polyethylene, nylon, elastomeric pads, or metallic wear plates.

10. The system of claim 2, further comprising a secondary lock configured to secure the forks within the skid restraint pockets.

11. The system of claim 1, wherein the winch assembly includes a load brake or ratchet configured to prevent back-drive during loading, and the tilt jack includes a limit switch or angle sensor configured to inhibit over-tilt.

12. A trailer assembly comprising:
a trailer portion;
a tilt deck pivotally coupled to the trailer portion via a rotatable joint and movable between a loading position and a transport position;
a tilt jack mounted between the trailer portion and the tilt deck and operable to move the tilt deck between the loading position and the transport position;
a winch assembly mounted on the trailer portion;
a pair of skid restraint pockets formed at a rear portion of the tilt deck;
a cam-lock subassembly mounted to the tilt deck and configured to engage a cam-lock skid pin on a skid; and
a plurality of jack pockets formed through the tilt deck and positioned to align with leveling jacks of a skid while the skid remains seated on the tilt deck.

13. The trailer assembly of claim 12, wherein, in a locked position, a cam-lock arm of the cam-lock subassembly forms an angle between 30 and 70 degrees relative to a plane of the tilt deck.

14. The trailer assembly of claim 12, wherein the jack pockets include welded collars or reinforcing sleeves configured to distribute jack loads into the tilt deck structure.

15. The trailer assembly of claim 12, wherein, in the transport position, the tilt deck overlaps an axle or trailer frame member to increase transport stability.

16. A skid assembly comprising:
a base frame;
a pair of forks extending from a rear portion of the base frame and configured to seat within complementary skid restraint pockets of a trailer tilt deck;
a protruding cam-lock skid pin configured for engagement by a cam-lock arm mounted to the trailer tilt deck; and
a plurality of leveling jacks positioned to align with jack pockets of the trailer tilt deck when the skid is seated on the trailer.

17. The skid assembly of claim 16, wherein the forks include tapered leading portions and grooves or shoulders configured to engage mating features within the skid restraint pockets.

18. The skid assembly of claim 16, further comprising rollers positioned adjacent edges of the base frame.

19. The skid assembly of claim 18, wherein the rollers include sealed bearings and the roller mounts are corrosion-resistant.

20. The skid assembly of claim 16, wherein the cam-lock skid pin includes a hardened surface or a wear sleeve.
